(19) United States
(12) Patent Application Publication
(10) Pub. No.: US 2015/0074938 A1
(43) Pub. Date: Mar. 19, 2015

(54) Hydraulic Fluid Flow Management System and Method

(71) Applicant: Alamo Group, Inc., Seguin, TX (US)

(72) Inventors: Tracy Day, Bellevue, WA (US); John Day, Maple Valley, WA (US)

(73) Assignee: ALAMO GROUP, INC., Seguin, TX (US)

(21) Appl. No.: 14/528,354

(22) Filed: Oct. 30, 2014

Related U.S. Application Data
(63) Continuation of application No. 12/732,028, filed on Mar. 25, 2010, now abandoned.
(60) Provisional application No. 61/211,098, filed on Mar. 26, 2009.

(51) Int. Cl. E01H 1/00; F15B 13/02; E01H 1/05; F15B 11/08

(52) U.S. Cl. CPC E01H 1/005; F15B 11/08; F15B 13/02; E01H 1/053
USPC 15/340.3; 60/445; 60/459

(57) ABSTRACT

A hydraulic fluid flow management system and method includes three subsystems. The first subsystem is an engine mounted hydraulic fluid pump electrically operated flow control proportioning valve combination. The second subsystem is a hydraulic fluid flow distribution manifold assembly. The third subsystem is a computer operated controller and display which governs the operation of the electrically operated flow control proportioning valve combination.

### CROSS REFERENCE TO RELATED APPLICATION

This application claims the benefit of Provisional U.S. Patent Application No. 61/211,098 filed Mar. 26, 2009 and is a continuation of U.S. patent application Ser. No. 12/732,028 filed Mar. 25, 2010.

### STATEMENT REGARDING FEDERALLY FUNDED RESEARCH AND DEVELOPMENT

The invention described in this patent application was not the subject of federally sponsored research or development.

### FIELD

The present invention pertains primarily to vehicles designed for transporting and then operating equipment using a hydraulic fluid flow system; more particularly, the present invention pertains to a hydraulic fluid flow management system which provides a variable flow of hydraulic fluid to operate equipment mounted on the vehicle. Those of ordinary skill in the art will understand that while the disclosed system and method is described in terms of its use on a self-propelled vehicle, the equipment used to implement the disclosed system and method may be mounted on a trailer, a railroad car or a stationary surface having sufficient space to accommodate hydraulic fluid flow operated equipment.

### BACKGROUND

The use of a hydraulic fluid to operate hydraulic cylinders to produce linear mechanical forces and/or to cause hydraulic motors to produce rotational mechanical forces has become common particularly on commercial vehicles used in include dump trucks, tanker trucks, fire trucks, well service trucks, garbage trucks, snow removal trucks, construction equipment and pavement sweepers among others.

The current invention will be described in terms of its use and mounting on a pavement sweeper; however, those of ordinary skill in the art will understand that the disclosed system and method has utility on any type of vehicle or fixed installation whose operation depends on the flow of hydraulic fluid to hydraulic motors, hydraulic cylinders or other equipment operated by the flow of hydraulic fluid.

For many years working vehicles that carried equipment typically used a separate small auxiliary internal combustion engine or a mechanical connection to a power take-off from the transmission or drive train of the transporting vehicle to provide the needed mechanical power to operate the equipment carried by the vehicle. The next generation of working vehicles changed the power supply from a direct mechanical connection to a separate small auxiliary motor or a power take-off connection to either a combination of a mechanical connection with some combination of hydraulic fluid powered components or a system using all hydraulic fluid powered components. The prior art systems using all hydraulic fluid powered components were easily recognizable by the many tubes, fittings and connections used to manage hydraulic fluid flow. Such prior art hydraulic systems often used multiple pumps or required that one section of the hydraulically operated equipment be shut down while other sections of hydraulically operated equipment were put into use. Oftentimes it has been necessary to both carry large amounts of hydraulic fluid and to run the vehicle engine at a higher rotational flow of hydraulic fluid.

Emission requirements in many states have targeted limiting the use of small auxiliary internal combustion engines similar to those used to power the equipment on prior art working trucks. Accordingly, there is a need to find an alternative to the separate small auxiliary engines or motors used to partially or completely power the equipment carried by working trucks.

Many prior art working trucks that use hydraulic fluid flow to operate the equipment mounted on the truck use a hydraulic fluid pump that is mounted to the frame of the vehicle. One or more belts from either the engine or the transmission provide the needed rotational power to turn the pump. This frame-mounting arrangement of the pump causes two problems. First, the place on the frame for mounting the pump may include some sort of structural brace or may provide a mounting for parts to another system. Such a structural brace of mountings for other parts complicates the installation of a frame mounted pump. Secondly, the drive portion of each pump must be manually aligned with the engine or transmission. Any misalignment between the drive portion of the engine or transmission and the drive portion of the pump shortens drive belt life, creates vibrations felt in the drivers compartment, and accelerates the wear of the bearings in the pump.

Control over the volume of flow of hydraulic fluid from the hydraulic pump to the service equipment mounted on prior art trucks is typically done mechanically. A knob or rotating control connected to a throttle cable is made available to the driver. A gauge providing a reading indicative of the pressure of fluid flow is placed near the driver's compartment. In some prior art pavement sweepers, a hydraulic fluid flow pressure gauge is placed behind the driver's compartment. Thus, to attain the desired setting on the fluid flow pressure gauge, the driver may have to turn around to look at the pressure gauge, then turn a knob to obtain the desired setting on a pressure gauge. The throttle cable which is mechanically attached to the knob adjusts a valve which regulates the pressure of the hydraulic fluid to the hydraulically operated service equipment on the back of the truck.

There is, therefore, a need in the art for a hydraulic fluid flow management system and method which is simple to use, easy to install and easy to service.

### SUMMARY

The disclosed hydraulic fluid flow management system and method of the present invention is simple to use, easy to install, and easy to service.

The disclosed hydraulic fluid flow management system and method has three subsystems.

The first subsystem is the engine mounted hydraulic fluid pump and electrically operated flow control proportioning valve combination.

The second subsystem is the modular hydraulic flow distribution manifold assembly which receives the hydraulic fluid from the engine mounted hydraulic fluid pump and electrically operated flow control proportioning valve combination. This modular manifold assembly guides the hydraulic fluid to the various locations where it is needed to operate hydraulic equipment such as hydraulic motors and hydraulic cylinders. For example, in a pavement sweeper, the modular hydraulic fluid flow distribution manifold assembly guides the flow of hydraulic fluid to a fan motor. The fan motor turns the fan responsible for creating a negative pressure at the debris pick-up head and within the debris retention hopper. This negative pressure enables debris to be sucked up by the pick-up head and conveyed to the debris retention hopper.

The hydraulic fluid from the modular manifold assembly is also directed to the hydraulic cylinders which are used to position the debris pick-up head in relation to the surface of the pavement being swept and to position the hydraulic cylinders which cause the debris retention hopper to move to a dump position when it becomes necessary to empty the collected debris from the debris retention hopper.

Yet additional hydraulic fluid from the modular flow distribution manifold assembly is directed to a hydraulic motor which turns one or more rotating curb broom(s) and activates the hydraulic cylinder(s) which position the small rotating curb broom(s) with respect to the ground surface being swept.

The third subsystem is the computer operated controller and display. The computer operated controller and display sends an electrical signal to the electrically operated flow control proportioning valve to regulate the flow of hydraulic fluid from the engine mounted and engine driven variable displacement hydraulic piston pump.

The computer operated controller and display is mounted in the driver's compartment, typically in or under the dashboard. The flow control portion on the face of the computer controlled display is segmented into substantially ten percent flow increments up to 100% which are sent to the electrically operated flow control proportioning valve. In most situations, it is expected that the driver will set the computer controlled display somewhere between 60% to 100% flow.

### BRIEF DESCRIPTION OF THE DRAWING FIGURES

A still better understanding of the hydraulic fluid flow management system and method may be had by reference to the drawing figures, wherein:

FIG. 1 is a side elevational view of a pavement sweeper as being an example of a vehicle on which the hydraulic fluid flow management system and method would have utility;

FIG. 2 is an exemplary schematic of a prior art hydraulic fluid flow system heretofore used on a vehicle such as shown in FIG. 1; system and method;

FIG. 3 is a general schematic of the hydraulic fluid flow system and method of the present invention;

FIG. 4 is a schematic flow chart illustrating the interconnection of the componentry of the disclosed system and method;

FIG. 5 is a schematic diagram illustrating the mounting of the hydraulic fluid pump on the engine of the vehicle; and

FIG. 6 is an elevational view of the computer operated display available to the operator of the disclosed system and method.

### DESCRIPTION OF THE EMBODIMENTS

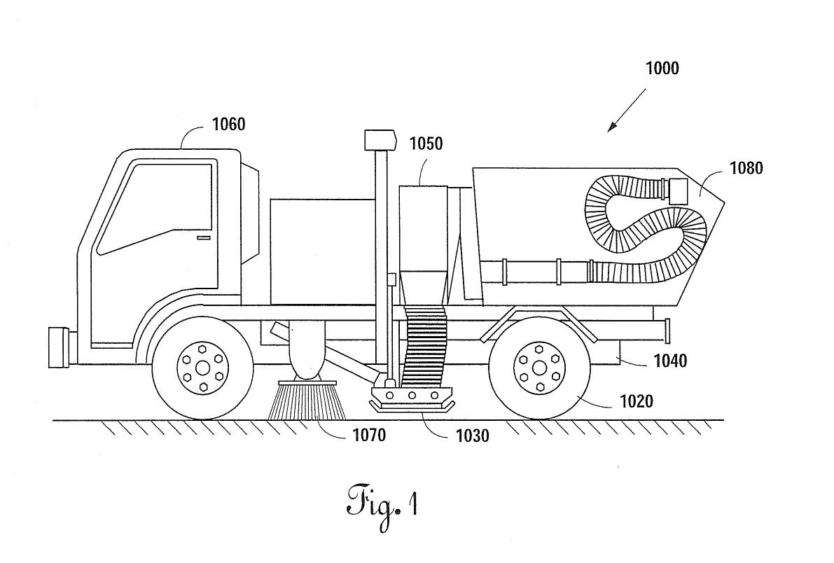

As explained above, the hydraulic fluid flow management system and method 100 of the present invention may be used on a variety of different types of vehicles or in different settings. The pavement sweeper 1000 shown in FIG. 1 and on which the following description is based is typically used by government agencies or by sanitation contractors for street sweeping and private companies for cleaning parking lots. Sweeper 1000 is but one example of the many types of vehicles on which the disclosed invention may be used.

A glossary of the terms used in this Description of the Embodiments follows:
100 hydraulic fluid flow management system and method;
200 engine driven pump and electrically operated flow control proportioning
valve combination;
210 engine mounted variable displacement hydraulic piston pump;
211 filter;
220 electrically operated flow control proportioning valve;
221 filter;
230 modular fluid flow distribution manifold assembly;
231 flow control (on/off) valve;
232 pressure relief valve;
233 check valve;
234 flow limiter;
235 flow control (on/off) valve;
236 pressure relief valve;
237 check valve;
242 fixed displacement axial hydraulic motor;
252 debris collection hopper positioning hydraulic cylinders;
254 pick-up head positioning hydraulic cylinders;
258 check valve;
260 computer operated controller;
262 auxiliary power port;
263 auxiliary power port;
264 sweep mode icon;
266 curb broom icon;
268 spot light icon;
270 warning light icon;
272 spot light movement buttons;
280 display;
282 vertical bar graph;
298 electrical signal;
299 electrical signal;
910 pump;
915 mechanical cable and linkage assembly;
920 one-way valve;
925 fixed displacement hydraulic motor;
926 radial turbine fan;
930 pick-up head positioning hydraulic cylinders;
935 debris retention hopper positioning hydraulic cylinders;
940 small separate fixed displacement gear pump;
945 curb broom positioning hydraulic cylinder;
950 curb broom motor;
955 valving;
960 valving;
965 hydraulic fluid reservoir;
970 filter;
1000 pavement sweeper;
1020 wheels;
1030 pick-up head;
1040 chassis frame;
1050 fan assembly;
1060 driver's compartment;
1070 rotating broom assembly;
1080 debris retention hopper.

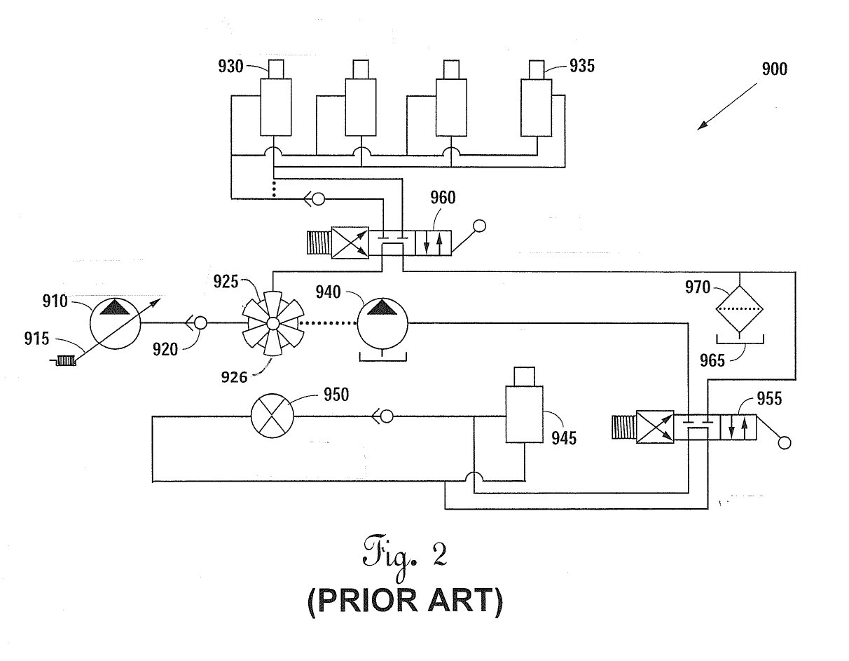

As explained above, prior art systems used on a sweeper 1000 such as the exemplary sweeper shown in FIG. 1, have used a mechanical cable 915 (FIG. 2) to increase or decrease the hydraulic fluid pressure from the engine driven hydraulic fluid pump 910. This change in hydraulic fluid pressure increases or decreases the flow of hydraulic fluid. In the prior art system shown in FIG. 2 the speed of the fan assembly which creates the negative pressure at the debris pick-up head is determined by the hydraulic fluid pressure output from pump 910 to a fixed displacement axial piston hydraulic motor 925. The axial piston motor 925 provides rotational force to turn the radial turbine fan 926 using a small separate fixed displacement gear pump 940. A small fixed displacement gear pump 940 causes hydraulic fluid to flow through a valve 955 to control a second fixed displacement gear pump 950 attached to the rotating curb broom assembly. The rotational speed of the curb broom itself is adjusted by the use of a mechanically controlled adjustable relief valve. The adjustable relief valve limits the amount of hydraulic fluid that can be returned to the hydraulic fluid reservoir 965.

The pavement sweeper 1000 shown in FIG. 1, like most road vehicles has four or more wheels 1020 which are mounted to a chassis frame 1040. Mechanical power which causes the drive wheels 1020 to turn, typically the rear wheels, is provided by an engine/transmission combination (not shown) located at the front of the vehicle 1000. In the vehicle 1000 shown in FIG. 1, the engine/transmission combination is located underneath the driver's compartment 1060. Such design is often referred to as a “cab over” design as the entire driver's compartment 1060 can be tilted forward to provide access to the engine/transmission combination. The remaining part of the vehicle 1000 is the space behind the driver's compartment 1060 wherein the equipment to be transported by the vehicle, to include the fan assembly 1050, is placed. Those of ordinary skill in the art will understand that the system and method of the present invention may also be used in conventional vehicles where the engine is located in front of the driver's compartment 1060.

At the very back of the equipment space is a debris retention hopper 1080 for holding the debris picked up from the pavement surface by the negative pressure at the pick-up head 1030. The debris retention hopper 1080 is made to tilt so that when the debris retention hopper becomes full of debris, the debris retention hopper 1080 may be positioned to enable the debris collected from the pavement surface to fall out. Such tilting of the debris retention hopper 1080 is caused by the extension of the hydraulic cylinders 935 (not shown in FIG. 1) located underneath the debris retention hopper 1080.

As previously indicated, debris from the area of pavement being swept is lifted into the hopper 1080 by a negative pressure at the pick-up head 1030. This negative pressure is caused by a fan assembly 1050 located at the entrance to the hopper 1030. The position of the pick-up head 1030 is set to ride close to the ground surface to the enable the greatest removal of debris from the ground surface by the negative pressure at the pick-up head 1030.

Shown in FIG. 1, on the driver's side of the vehicle, is a rotating curb broom assembly 1070 turned by motor 950. The rotating curb broom assembly 1070 loosens debris from the ground surface and moves it toward the debris pick-up head 1030. Such rotation of the curb broom assembly 1070 is caused by the rotation of a small hydraulic motor. The rotating curb broom assembly 1070 is moved into a position wherein the ends of the bristles of the rotating broom will contact the ground surface being cleaned near a curb. Such location of the rotating curb broom assembly 1070 is controlled by a hydraulic cylinder 945. If desired, a second rotating curb broom assembly 1070 may be placed on the opposite side of the pavement sweeper 1000.

A still better understanding of an exemplary prior art fluid flow system 900 used on the vehicle 1000 such as that depicted in FIG. 1 may be had by reference to the exemplary prior art hydraulic fluid flow system 900 as shown in FIG. 2.

In FIG. 2, it may be seen that fluid flow in a prior art system begins at a hydraulic pump 910 whose output is controlled by throttle cable 915 or mechanical cable and linkage assembly as discussed above. Fluid from the hydraulic pump 910 passes through a one-way valve 920 to a fan motor 925 which drives the fan 926 mounted on the front of the debris retention hopper 1080 as shown in FIG. 1. Recall that it is the fan 926 which produces a negative pressure at the pick-up head 1030 which negative pressure draws debris into the debris retention hopper 1080.

In the exemplary prior art fluid flow system shown in FIG. 2, the hydraulic fluid pressure and flow volume from the hydraulic fluid pump 910 driven by the engine is typically not sufficient to supply the needed power to drive the pick-up head locating cylinders 930 or the debris retention hopper cylinders 935 particularly when the vehicle's engine is at idle speed. Thus, an additional hydraulic pump 940 is needed to assure that the needed hydraulic fluid flow, at the desired pressure, is supplied. This additional flow of hydraulic fluid is also used to provide the hydraulic fluid needed to move the rotating curb broom assembly positioning cylinder 945 and to cause the curb broom motor 950 to turn. Appropriate valving 955, 960 is used to assure the flow of hydraulic fluid for controlling the operation of the hydraulically operated equipment. A hydraulic fluid reservoir 965 and filter 970 is used to assure that the proper amount of clean hydraulic fluid is supplied.

In many prior art systems, the nest of hoses and connections created from the implementation of the system shown in FIG. 2 is complicated, time consuming to install and difficult to service.

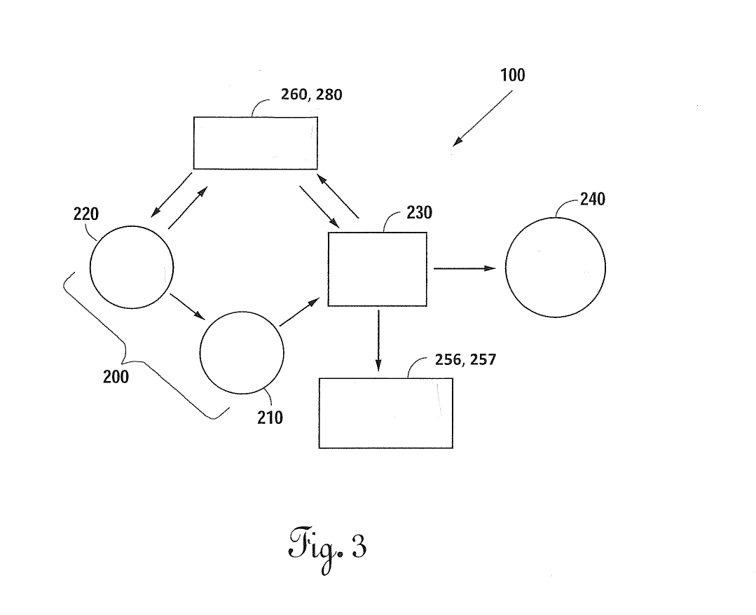

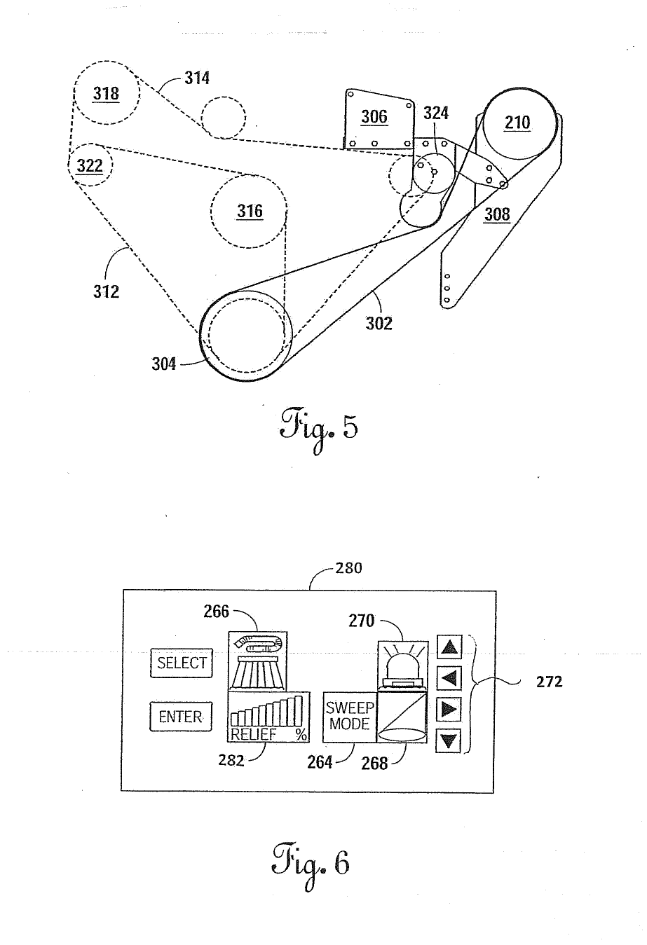

As shown in FIG. 3, the system and method of the present invention 100 is implement by the use of three subsystems. The first subsystem is the engine mounted, variable displacement hydraulic piston pump 210 and electrically operated flow control proportioning valve 220 combination 200. Rotational power for the variable displacement hydraulic piston pump 210 is provided directly from the front of the crank shaft of the vehicle's engine using a pulley 304 which engages a dedicated belt 302 as shown in more detail in FIG. 5. To assure proper tensioning of the dedicated pump drive at all times, a belt tensioner 324 made by the Gates Corporation of Denver, Colo. is used.

The engine driven and engine mounted variable displacement hydraulic piston pump 210 used in the preferred embodiment is made by Casappa of Parma, Italy. The electrically operated flow control proportioning valve 220 is made by Hydraforce, Inc. of Lincolnshire, Ill. Unlike prior art systems, the variable displacement hydraulic piston pump 210 of the disclosed system and method is mounted directly to the engine block and cylinder head. Such mounting to the engine block and cylinder head reduces the vibration felt by the driver when a prior art hydraulic fluid pump is mounted to the frame of the vehicle. Such mounting of the variable displacement hydraulic piston pump 210 to the engine also provides extended life for the variable displacement hydraulic piston pump drive belt 302.

The flow of hydraulic fluid exiting the variable displacement hydraulic piston pump 210 passes through the electrically operated flow control proportioning valve 220 before entering the hoses which lead to the second subsystem, the modular flow distribution manifold assembly 230 located in the equipment space behind the driver's compartment 1060.

Within the modular flow distribution manifold assembly 230 is a fluid flow divider configuration. The fluid flow divider configuration assures that the needed amount of hydraulic fluid at the required pressure is provided to the hydraulic motor 242 which drives the radial turbine fan assembly 240. The hydraulic cylinders 254 which cause the debris retention hopper to tilt, the hydraulic cylinders 252 which position the debris pick-up head, the hydraulic cylinder(s) 256 which position the rotating curb broom(s) also are placed downstream from the modular flow distribution manifold assembly 230. All required valving is contained within the modular flow distribution manifold assembly 230. Thus, if there is an operational problem, a service technician does not need to troubleshoot the entire hydraulic system; rather, the modular flow distribution manifold assembly 230 is simply replaced.

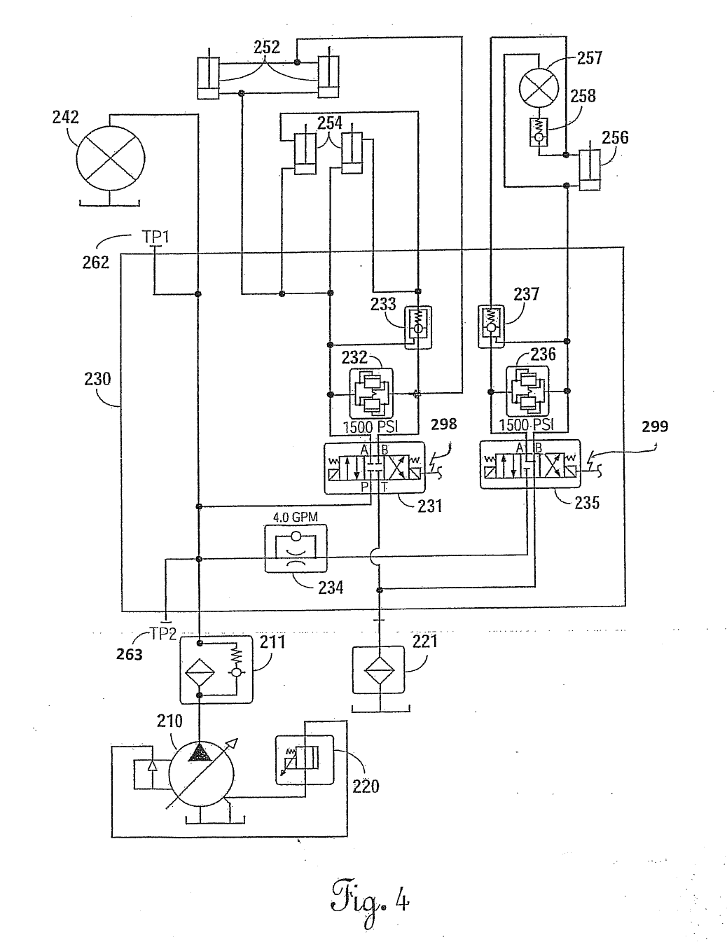

Within the driver's compartment 1060 is the third subsystem, the computer operated controller 260 and display 280 which governs the operation of the electrically operated flow control proportioning valve 220. When the vehicle is not being used for cleaning an area of pavement, there is a switch available to the driver which places the hydraulic fluid flow management system 100 is a shut-down or “road mode”. The road mode save fuel. When the vehicle arrives at a new job site, the road mode of operation is turned off and a “sweep mode” operation is initiated by the driver. Initiation of the sweep mode sends an electrical signal 298 to the flow control valve 231 and an electrical signal 299 to the flow control valve 235 as is shown in FIG. 4.

Control over the speed of the rotating curb broom assembly 1070 and the amount of negative pressure at the debris pick-up head is directly related to the volume of hydraulic fluid flow. To set the amount of hydraulic fluid flow needed to properly sweep the surface to be traversed by the sweeper vehicle, the driver is presented with a computer operated visual monitor 280 connected to a controller 260. The visual monitor 280 has display resembling a bar graph as described below. The low flows of hydraulic fluid are represented by a short vertical bar as a percentage of the left side of the display and higher flows of hydraulic fluid represented as a longer vertical bar on the right side of the display. While normal operation is at full flow or at a substantially 100% on the bar graph display, certain dusty conditions are better cleaned with a lower flow of hydraulic fluid such as substantially 70%.

### Operation

The electrically operated flow control proportioning valve 220 is used to either increase or decrease the flow of hydraulic fluid emitted by the engine driven variable displacement hydraulic piston pump 210. As the level of flow of hydraulic fluid to the fixed displacement axial hydraulic motor 242 which turns the radial turbine fan assembly 240 increases, the pressure of the hydraulic fluid also increases. This increase in hydraulic fluid pressure increases the horsepower output of the fixed displacement axial hydraulic motor 242 which is related to the quantity of hydraulic fluid flow, and the torque output, related to the flow pressure of the hydraulic fluid. Thus, the speed of the radial turbine fan assembly 240 spools up as the horsepower and torque output of the fixed displacement axial hydraulic motor 242 increase.

Changes in the flow of hydraulic fluid are regulated and controlled by driver inputs to the computer operated controller 260 by using the display 280 mounted in the driver's compartment 1060. As previously indicated, the computer operated controller 260 and display 280 enables two modes, a road mode and a sweep mode. The road mode is used when the vehicle is traveling between jobs and there is no need for a flow of hydraulic fluid to the equipment located on the back of the vehicle. In the sweep mode the hydraulic fluid provided to the equipment located on the back of the vehicle. In the road mode the electrically operated flow control proportioning valve 220 is automatically set to 0% flow. In the sweep mode, the electrically operated flow control proportioning valve 220 is energized according to a setting established by the driver after evaluating the debris to be picked up and the condition of the surface to be swept.

The logic in the computer operated controller 260 and display 280 (FIG. 6) is programmed with a short ramp up function to prevent a sudden impact on the drive belts and engine components. The ramp up function also provides a soft start to the hydraulic fluid power management system 100 and the variable displacement hydraulic piston pump 210 mounted on the engine.

The computer operated controller 260 and display 280 also retains a memory between the road mode and the sweep mode. This memory eliminates the need for the driver to reset the hydraulic fluid power management system 100 each time that there is a switch from road mode to sweep mode.

The computer operated controller 260 and display 280 also controls the rate of hydraulic fluid flow increase and then converts the input signal into the vertical bar graph 282 on the driver's display 280 where each bar represents a substantially 10% increase in the flow of hydraulic fluid as shown in FIG. 6. The driver simply pushes a button to desired amount of flow and the proper electrical signals are sent to the electrically controlled flow proportioning valve 220. To centralize control, the computer operated controller 260 and display 280 also includes an icon 264 verifying that the vehicle is in the sweep mode. Operation of optional equipment such as the curb broom, a spot light (to include spot light movement buttons 272), flashing warning lights, dust suppression water flow (not shown) may all be represented by icons 266, 268, and 270 respectively on the computer operated display 280.

The hydraulic fluid exiting the variable displacement hydraulic piston pump 210 whose flow is regulated by the electrically controlled flow proportioning valve setting placed on the visual display 280 by the driver, is directed to a modular flow distribution manifold assembly 230 which may be mounted in close proximity to equipment powered by the flow of hydraulic fluid. As shown in FIG. 4, the modular flow distribution manifold assembly 230 contains all of the necessary componentry to direct the flow of hydraulic fluid as well as the pressure relief valve 236 in the rotating curb broom assemblies and the pressure relief valve 232 before both the hopper positioning hydraulic cylinders 252 and pick-up head positioning hydraulic cylinders 254. The modular design of the flow distribution manifold assembly 230 allows for easy adjustment and maintenance. The need for a complicated nets of fittings and hoses to connect the various pilot operated check valves, relief valves, and solenoid valves is eliminated by the used of the disclosed system and method

Those of ordinary skill in the art will understand that the hydraulic fluid flow circuit shown in FIG. 4 is divided into three parts. On the left side of the hydraulic fluid flow circuit shown in FIG. 4 is the first part which conducts fluid to the fixed displacement axial hydraulic motor 242 which turns the radial fan assembly 240. Because there are no flow control valves, relief valves, or flow limiters in this part of the circuit, the hydraulic motor 242 receives a flow of hydraulic fluid whenever there is output from the electrically controlled flow proportioning valve 220. Because the radial fan assembly 240 is always turning in sweep mode, there is always a negative pressure enabling the pick-up of debris by the pick-up head.

In the middle of the hydraulic fluid flow circuit shown in FIG. 4 is the second part which conducts hydraulic fluid to the hydraulic cylinders 252 which control the position of the debris collection hopper 1080 and the hydraulic cylinders 254 which control the position of the pick-up head 1030 with respect to the ground. On/off flow control valve 231, when actuated by electrical signal 298 opens up the second part of the hydraulic fluid flow circuit to the flow of hydraulic fluid. As indicated above, there are no limitations to the flow of hydraulic fluid in the first part of the hydraulic fluid flow circuit including the fan motor 242. However, in the second part of the hydraulic fluid flow circuit shown in FIG. 4, pressure relief valve 232 limits the flow of hydraulic fluid to the debris collection hopper positioning hydraulic cylinders 252 and the pick-up head positioning hydraulic cylinders 254.

On the right side of the hydraulic fluid flow circuit shown in FIG. 4 is the third part of the hydraulic fluid flow circuit which conducts hydraulic fluid to the hydraulic cylinder(s) 256 which control the position of the rotating curb broom(s) and the motor 257 which turns the rotating curb broom(s). On/off flow control valve 235, when activated by electrical signal 299, opens up the third part of the hydraulic fluid flow circuit to the flow of hydraulic fluid. As indicated above, there are no limitations to the hydraulic fluid in the first part of the hydraulic fluid flow circuit including hydraulic motor 242. And, as indicated above, there is a hydraulic relief valve 232 in the second part of the hydraulic fluid flow circuit which restricts the flow of hydraulic fluid to the two sets of positioning hydraulic cylinders 252 and 254. In the third part of the hydraulic circuit which conducts hydraulic fluid to the curb broom positioning cylinder(s) 256 and the curb broom motor(s) 257 there is not only a relief valve 236, but there is also a flow limiter 234 which is set to a hydraulic fluid flow rate of about 4.0 gpm in the preferred embodiment.

In sum, the hydraulic fluid flow circuit shown in FIG. 4 shows a first part which has no flow restricting relief valves or flow limiters to enable continuous operation of a hydraulically powered motor whenever there is hydraulic fluid flow from the electrically controlled flow control proportioning valve. In the second part of the hydraulic fluid flow circuit shown in FIG. 4, there is an on/off hydraulic fluid flow control valve and a relief valve which enables the operation of positioning cylinders whenever the on/off hydraulic fluid flow control valve allows hydraulic fluid to flow into the second part of the hydraulic fluid flow circuit. Then in the third part of the hydraulic fluid flow circuit shown in FIG. 4, there an on/off hydraulic fluid flow control valve, a relief valve and flow limiter which enables the operation of hydraulically operated devices at a flow rate determined by the flow limiter whenever said on/off hydraulic flow control valve permits the flow of hydraulic fluid and the hydraulic fluid pressure in the third part of the hydraulic fluid flow circuit is sufficient to enable the flow of hydraulic fluid through the relief valve.

As may be further seen in FIG. 4, the variable displacement 210 output flow is limited by the electrically operated flow control proportioning valve 220. Hydraulic fluid entering the modular hydraulic fluid flow distribution manifold assembly 230 passes through a filter 211 on its way to the control valve 231, relief valve 232 and a check valve 233 combination. The position of the control valve 231 is determined by electrical signal 298. The hydraulic fluid which does not pass through the pressure/flow control 234 operates the cylinders 252 which tilt the debris collection hopper and the hydraulic cylinders 254 which vertically position the pick-up head as well as operate the fan motor 242. The hydraulic fluid which flows through the flow limiter 234, the second flow control valve 235, which is positioned by electrical signal 299, relief valve 236 and check valve 237 combination goes on to operate the curb broom(s) positioning cylinder 256 which position the rotating curb broom broom(s) and the motor(s) 257 which cause the rotating curb broom(s) to turn. As may be seen in FIG. 4 a flow control check valve 258 is placed between motor 257 and cylinder 256. Both the variable displacement hydraulic piston pump 210 and the electrically operated flow control proportioning valve 220 are protected by filters 211, 221.

Another key feature of the disclosed system and method are the two auxiliary hydraulic fluid power ports 262 and 263 located in the first part of the hydraulic fluid flow circuit including the motor 242, as shown in FIG. 4. Such fluid power ports 262 and 263 enable a variety of equipment to be mounted to and powered by the disclosed hydraulic fluid flow circuit. For example, a hydraulically operated positionable snow plow could be mounted to the front of a sweeper and a hydraulically operated sand spreader could be attached to the rear of a sweeper. If a sweeper is used to clean up an area following a storm, one auxiliary power port could be used to power an arm for picking up small trees or branches and loading them into another vehicle. The other power port could be used to power a trailer mounted chipper for chopping up small tress and sending the wood chips to another vehicle.

As shown in FIG. 5, the variable displacement hydraulic fluid piston pump 210 receives power from a dedicated drive belt 302 connected to a pulley 304 mounted on the end of the crankshaft of the engine. Brackets 306, 308 may be used to mount the variable displacement hydraulic fluid piston pump 210 to the top of the engine for easy assembly and maintenance. Existing serpentine belts 312, 314 shown in dashed lines may still be use to power the various items typically driven by the engine such as a water pump 316, an air conditioner compressor 318, an alternator and/or power steering pump 322. In the preferred embodiment the variable displacement hydraulic fluid piston pump 210 is driven with an eight groove, shallow V-belt which is tensioned by a spring loaded tensioner 324 as described above.

The disclosed system and method provides the following advantages:
a single hydraulic fluid pump can be used to operate multiple items of hydraulically powered equipment whether the equipment is vehicle mounted, trailer mounted, or in a fixed location;
auxiliary hydraulic fluid power ports are provided;
the flow controls, relief valves, etc. are contained in a modular distribution manifold assembly;
all items of service equipment may be operated while the engine remains at idle speed;
the system may be installed on a vehicle without having to move parts of the truck installed by the truck manufacturer;
the system is emission free and is eco-friendly as it may be used with biodegradable hydraulic fluid.

While the disclosed system and method has been explained according to the illustrated embodiment, those of ordinary skill in the art will understand that numerous other embodiments and modifications thereof may be made without departing from the disclosed system and method. Such other embodiments and modifications shall be included within the scope and meaning of the appended claims.

We claim:

1. A hydraulic fluid flow management system for use on a vehicle having an engine positioned in an engine compartment, a compartment for the driver of the vehicle, and a space for the mounting of equipment made operable by the use of flowing hydraulic fluid, said hydraulic fluid flow management system comprising:
a hydraulic fluid pump system, said hydraulic fluid pump system including a pump mounted to the engine of the vehicle in a position enabling the receipt of rotational power from the engine and an electrically operated flow control proportioning valve for receiving the output of hydraulic fluid from said engine mounted pump;
a modular hydraulic fluid flow distribution manifold assembly for guiding the flow of hydraulic fluid from said hydraulic fluid pump system to the equipment made operable by the use of flowing hydraulic fluid;
said modular fluid flow distribution manifold assembly including a three part hydraulic fluid flow circuit, wherein:
the first part of said three part hydraulic fluid flow circuit includes no flow flow limiters or relief valves and enables the continuous operation of a hydraulic fluid flow operated device whenever hydraulic fluid flow comes from said hydraulic fluid pump system;
the second part of said three part hydraulic fluid flow circuit includes an on/off flow control and a relief valve and enables the operation of a hydraulic fluid flow operated device whenever said on/off flow control is in the on position and the hydraulic fluid pressure in said second part of said three part hydraulic fluid flow circuit is sufficient to enable the flow of hydraulic fluid through said relief valve; and
the third part of said three part hydraulic fluid flow circuit includes an on/off flow control, a relief valve, and a flow limiter and enables the operation of a hydraulically fluid flow operated device at a flow rate determined by said flow limiter whenever said on/off flow control is in the on position and the hydraulic fluid flow pressure is sufficient to enable the flow of hydraulic fluid through said relief valve;
a fluid flow controller located in the compartment for the driver of the vehicle to incrementally enable the driver to control said electrically operated flow control proportioning valve.

2. The hydraulic fluid flow management system as defined in claim 1 wherein said pump mounted to the engine of the vehicle is a variable displacement hydraulic piston pump.

3. The hydraulic fluid flow management system as defined in claim 1 wherein said fluid flow controller enables controlling the flow of hydraulic fluid in substantially ten percent increments.

4. The hydraulic fluid flow management system as defined in claim 1 wherein at least one auxiliary fluid power port is included in said first part of said hydraulic fluid flow circuit.

5. A pavement sweeping vehicle comprising:
a vehicle chassis and drive train, said vehicle chassis and drive train including a frame, a set of steering wheels and a set of drive wheels attached to said frame, an engine and transmission combination for turning said drive wheels for causing the pavement sweeping vehicle to move over an area to be swept;
a driver's compartment mounted to said frame, said driver's compartment containing controls for operating said sweeping vehicle;
a hydraulically operated pavement sweeping system attached to said frame, said hydraulically operated pavement sweeping system including a fan, a positionable debris pick-up head assembly, a debris retention hopper, and at least one positionable rotating curb broom assembly;
a hydraulic pump system, said hydraulic pump system including a pump mounted to said engine enabling the receipt of rotational power from said engine and an electrically controlled hydraulic fluid flow proportioning valve for receiving the output of said engine drive pump;
a modular hydraulic fluid flow distribution manifold assembly for guiding the flow of hydraulic fluid from said hydraulic fluid pump system to said fan, said positionable pick-up head assembly and said positionable rotating curb broom assembly;
said modular hydraulic fluid flow distribution manifold assembly including a three part hydraulic fluid flow circuit wherein:
the first part of said three part hydraulic fluid flow circuit includes no flow restrictions and enables the continuous operation of a fan whenever the flow of hydraulic fluid comes from said electrically controlled hydraulic fluid flow proportioning valve;
the second part of said three part hydraulic fluid flow circuit includes an on/off flow control and a relief valve and enables the operation of hydraulic positioning cylinders whenever said on/off flow control is in the on position and the hydraulic fluid pressure in the second part of said hydraulic fluid flow circuit is sufficient to enable the flow of fluid through said relief valve;
the third part of said three part hydraulic fluid flow circuit includes an on/off flow control valve, a relief valve, and a flow limiter and enables the positioning an rotation of said rotating curb brooms at hydraulic fluid flow rate determined by said flow limiter whenever said on/off flow control is in the on position and the hydraulic fluid pressure in the third part of said hydraulic fluid flow circuit is sufficient to enable the flow of fluid through said relief valve;
a controller located in the driver's compartment to enable the driver to electrically control said fluid proportioning valve.

6. The pavement sweeping vehicle as defined in claim 5 wherein said pump mounted to said engine is a variable displacement hydraulic piston pump.

7. The pavement sweeping vehicle as defined in claim 5 wherein said controller enables control of the flow of hydraulic fluid in substantially ten percent increments.

8. The pavement sweeping vehicle as defined in claim 5 wherein at least one auxiliary fluid power port is included in said first part of said hydraulic fluid flow circuit.
